(19) United States
(12) Patent Application Publication
(10) Pub. No.: US 2012/0007875 A1
(43) Pub. Date: Jan. 12, 2012

(54) Multiple Monitor Video Control

(75) Inventors: Saravanan Sethuraman, Bangalore (IN); Sreekrishnan Venkiteswaran, Kerala (IN)

(73) Assignee: INTERNATIONAL BUSINESS MACHINES CORPORATION, Armonk, NY (US)

(21) Appl. No.: 12/834,129

(22) Filed: Jul. 12, 2010

(51) Int. Cl. G09G 5/36

(52) U.S. Cl. 345/545; 345/558

(57) ABSTRACT

A computer system comprising a processor including a display controller operative to output display data and a clock signal, and a programmable logic device communicatively connected to the processor, the programmable logic device including a first FIFO (first in first out) module operative to receive display data from the display controller and output display data to a display device, a second FIFO module, a scaler module communicatively connected to the first FIFO module and the second FIFO module operative to scale the display data received from the first FIFO module and output the scaled display data to the second FIFO module, and a synchronization generator operative to receive the clock signal from the display controller and to control the first FIFO and the second FIFO.

### BACKGROUND

The present invention relates to computer systems, and more specifically, to computer systems with multiple display monitors.

Using multiple display monitors in computer systems offers a user many display options. A user may, for example, operate a laptop computer using both an integrated monitor and an external monitor. Many computer systems incorporate multiple video controller systems to allow a computer system to control and output video simultaneously to multiple monitors (displays) that have different resolutions and dissimilar screen refresh rates. The video controller systems often include separate integrated circuits to control each monitor.

### BRIEF SUMMARY

According to one embodiment of the present invention, a computer system comprising a processor including a display controller operative to output display data and a clock signal, and a programmable logic device communicatively connected to the processor, the programmable logic device including a first FIFO (first in first out) module operative to receive display data from the display controller and output display data to a display device, a second FIFO module, a scaler module communicatively connected to the first FIFO module and the second FIFO module operative to scale the display data received from the first FIFO module and output the scaled display data to the second FIFO module, and a synchronization generator operative to receive the clock signal from the display controller and to control the first FIFO and the second FIFO.

According to another embodiment of the present invention, method for displaying data in a system includes receiving configuration data from a first display device and a second display device, comparing the configuration data to identify which display device operates at a higher resolution, configuring a first set of registers in the system with operating parameters associated with the higher resolution display, configuring a second set of registers in the system with operating parameters associated with the lower resolution display, receiving display data at the higher resolution and a pixel clock signal from a processor, clocking the display data at the higher resolution into a first FIFO (first in first out) module, scaling the display data from the higher resolution to the lower resolution, clocking the display data at the lower resolution into a second FIFO module, switching the display data at the higher resolution to the display device having higher resolution, and switching the display data at the lower resolution to the display device having lower resolution.

According to yet another embodiment of the present invention, a system comprising a processor operative to receive display data from a memory and output the display data and a pixel clock signal and a programmable logic device connected to the processor operative to receive the display data and the pixel clock signal and clock the display data into a first FIFO (first in first out) module, scale the display data from a first resolution into a second resolution, clock the scaled display data in the second resolution into a second FIFO module, switch the display data from the first FIFO module to an interface converter associated with a higher resolution device, switch the display data from the second FIFO module to an interface converter associated with a lower resolution device, and output the display data from the interface converters to the associated display devices.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates the orientation of partial views FIGS. 1A and 1B.

FIGS. 1A and 1B illustrate partial views that may be linked edge to edge an exemplary embodiment of a portion of a computer system.

FIG. 2 further illustrates an exemplary embodiment of the synchronization generator of FIGS. 1A and 1B.

FIGS. 3A and 3B illustrate a block diagram of a method for operating the system of FIGS. 1A and 1B.

### DETAILED DESCRIPTION

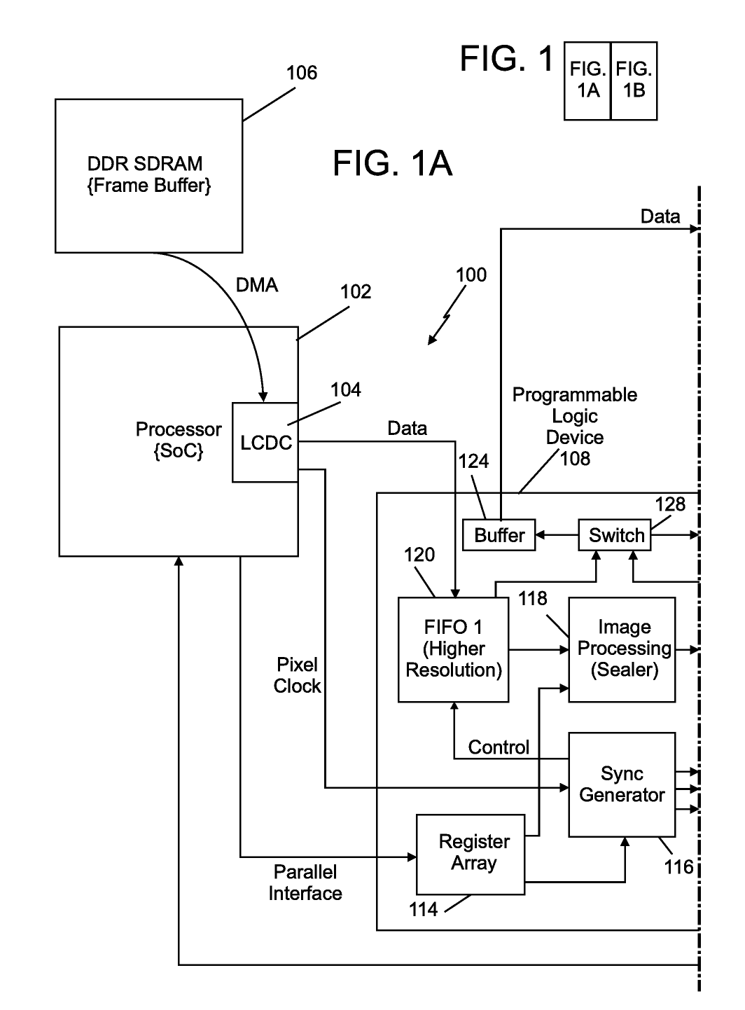

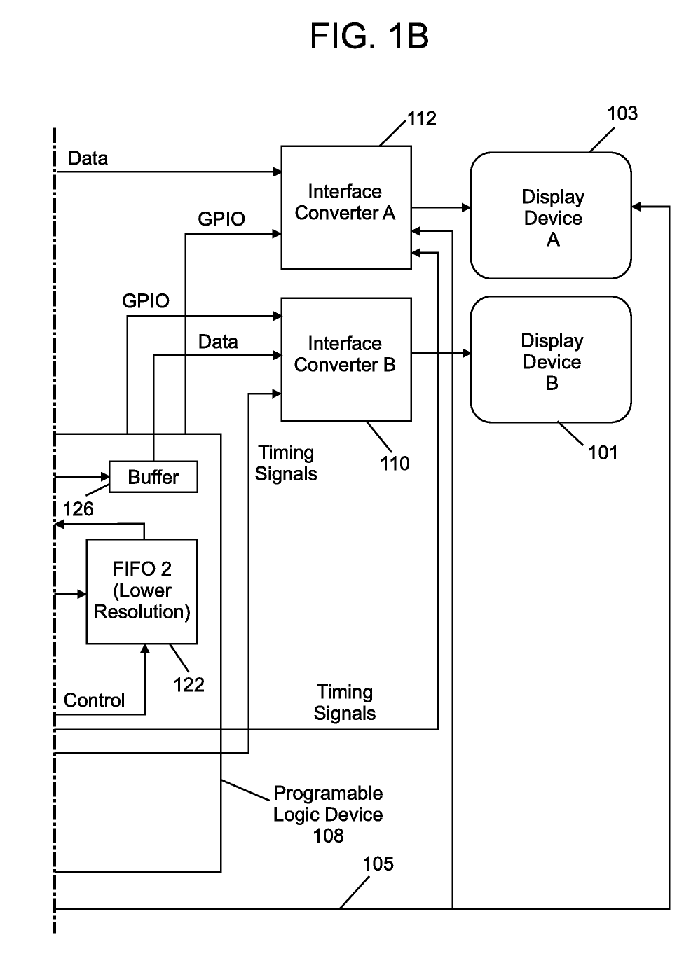

FIGS. 1A and 1B that may be linked edge to edge (as shown in FIG. 1) illustrate an exemplary embodiment of a portion of a computer system 100. The system 100 includes a processor 102. The processor may include any type of integrated circuit and may also include a system on chip (SoC) device. The processor 102 includes a display controller, in the illustrated embodiment, the display controller is a liquid crystal display controller (LCDC) 104, but may include any type of display controller. A memory device 106 is connected to the LCDC 104 via a direct memory access (DMA) connection. In the illustrated embodiment, the memory device 106 includes a double data rate synchronous dynamic random access memory (DDR SDRAM) device, but may include any type of memory device. The processor 102 and LCDC 104 are connected to a programmable logic device (PLD) 108. The PLD 108 is connected to an interface converter B 110 that is connected to a display device B 101. An interface converter A 112 is connected to the PLD 108, and the processor 102. A display device A 103 is connected to the interface converter A 112, and the processor 102. The processor 102 may be connected to the display device A 103 via, for example, a two wire interface 105. In the illustrated embodiment, the display device B 101 may include, for example, an integrated LCD, such as, a laptop device monitor, the display device A 103 may include an external display device such as a projector, or LCD display that may be communicatively connected to the computing system. The display device A 103 conforms to digital visual interface (DVI) standards or derivatives such as high-definition multimedia interface (HDMI). The system 100 may be adapted to implement other display standards.

The LCDC 104 includes a register array used to configure the display device having the higher resolution. The register array includes registers such as an LCD Screen Start Address Register, which defines the screen start address of LCD panel; an LCD Size Register, which defines the maximum X size (Horizontal) length and the maximum Y size (Vertical) length; a Virtual Page-width Register, which defines the width of the virtual page for the display panel; a Panel Configuration Register, which defines all the properties of the display panel such as clock polarity, pixel polarity, panel bus width, and color (either monochrome or color display); a Horizontal Configuration Register and Vertical Configuration Register, which defines the horizontal synchronization and vertical synchronization pulse timings, respectively; LCD Pulse-width Module Contrast Control Registers, which support display contrast variations; LCDC DMA Control Registers, which define the DMA burst length and when to trigger a DMA burst in terms of the number of data bytes left in the pixel buffer; LCDC Interrupt configuration registers, which define the interrupt enable/disable status; Frame Control registers and LCDC Refresh mode control registers, which decide the number of frames per second (fps), such as, for example, 25 fps for PAL and 30 fps for NTSC.

The PLD 108 includes a register array 114 used to configure the display device having the lower resolution, and also for general purpose Input/Ouput (GPIO) configuration. The PLD 108 is connected via a parallel interface to the processor 102. The register array 114 includes PLD registers such as an LCD Size register, which defines the maximum X size (Horizontal) length and the maximum Y size (Vertical) length; a Virtual Page width register, which defines the width of the virtual page for the display panel; a Panel Configuration register, which defines all the properties of the display panel such as clock polarity, pixel polarity, panel bus width, color (either monochrome or color display) etc.; a Horizontal configuration register and vertical configuration register, which define the horizontal synchronization and vertical synchronization pulse timing, respectively; an LCD Pulse width module contrast control registers, which define display contrast variations; an Image scaler configuration register, which define the image scaling factor; Image bits per pixel (bpp) configuration registers, which define the bits consumed per pixel required for both the displays; a PLD General Purpose Input Output (GPIO) registers, which define input/output configuration, data direction and data content; PLD timing control registers, which define the control signal timings for FIFO1 120 and FIFO2 122.

The register array 114 is connected to a synchronization generator module (sync generator) 116, and a scaler 118. The scaler 118 is connected to a FIFO 1 (First in First Out) module 120 and a FIFO 2 module 122. The sync generator 116 is also connected to the FIFO 1 module 120 and the FIFO 2 module 122. The switch 128 is also connected to the FIFO 1 module 120 and the FIFO 2 module 122. The switch 128 is communicatively connected to the interface converters A 112 and B 110 via buffer module 124 and buffer module 126, respectively.

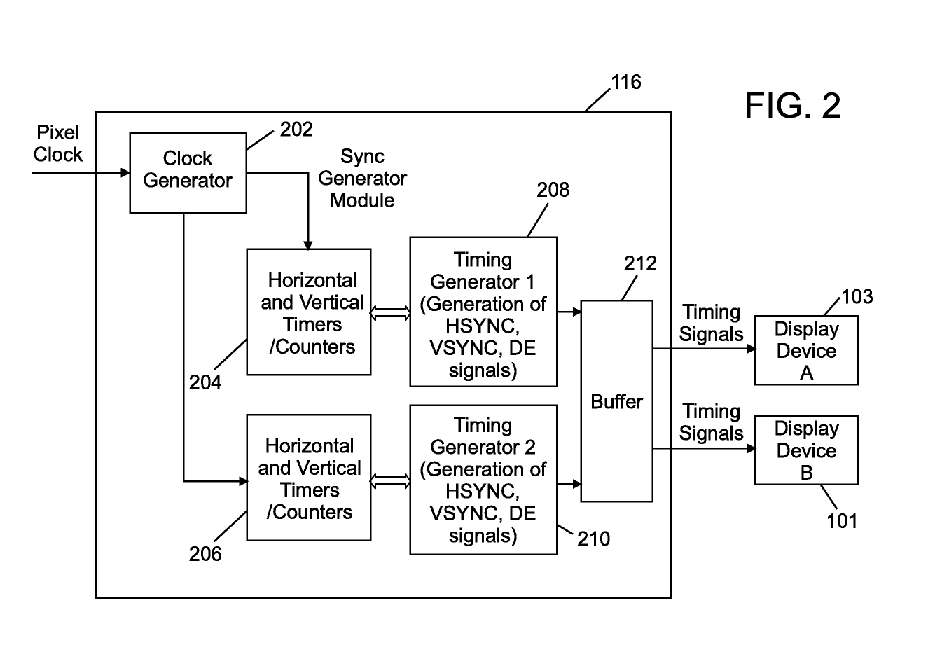

FIG. 2 further illustrates the sync generator 116. The sync generator 116 includes a clock generator 202 that receives a signal from the LCDC 104 (of FIGS. 1A and 1B) pixel clock. A first horizontal and vertical timer/counter 204 and a second horizontal and vertical timer/counter 206 are connected to the clock generator 202. The first horizontal and vertical timer/counter 204 is connected to a first timing generator 208, and the second horizontal and vertical timer/counter 206 is connected to a second timing generator 210. The timing generators 208 and 210 are connected to a buffer 212 that outputs timing signals to the display device B 101 and the display device A 103 respectively.

In operation, when the system 100 is powered on, applications write display data to the frame buffer 106. The LCDC 104 initiates DMA transfer from the frame buffer 106. The display device A 103 communicates via a serial interface with the processor 102 for communication and control. The display devices send extended display information data (EDID) or other configuration data to the processor 102, which accordingly updates the LCDC 104 registers and the PLD register array 114. The LCDC registers include the settings for the display device with higher resolution, while the PLD registers includes the register settings for the display device with lower resolution.

The image scaler configuration register in the PLD register array 114 is programmed to support the operation of the scaler 118. If the bits per pixel for the displays B 101 and A 103 are different, the bpp configuration registers include the bpp differences between the displays A103 and B101.

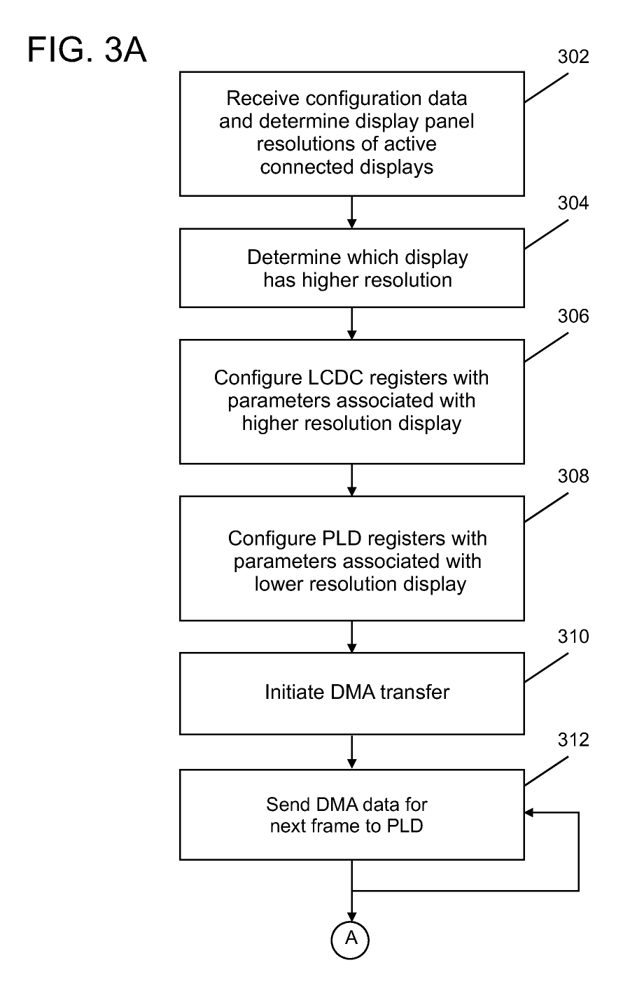

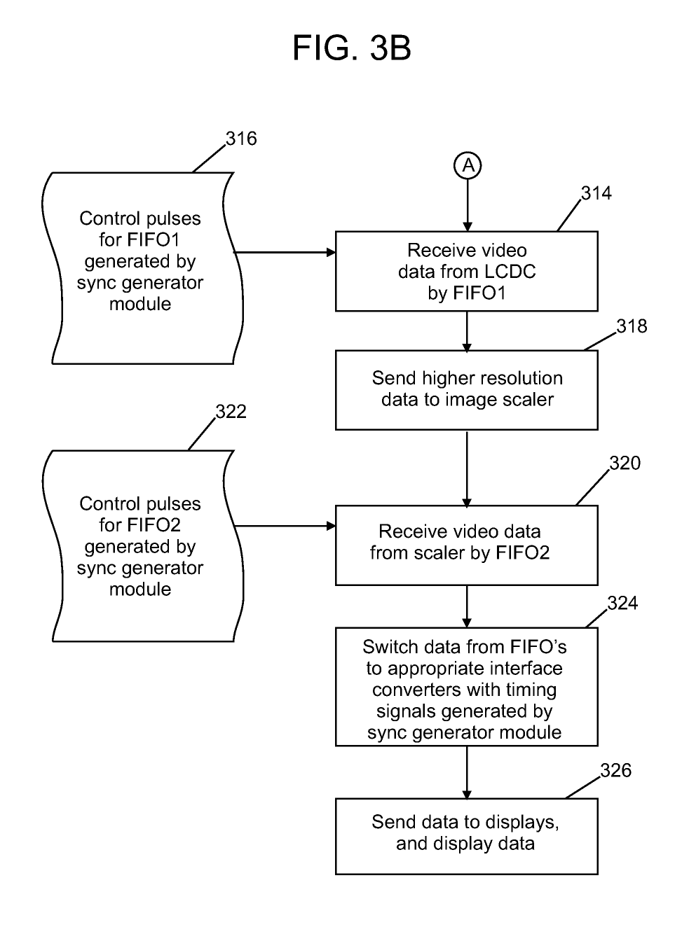

FIGS. 3A and 3B illustrate a block diagram of a method for operating the system 100 (of FIGS. 1A and 1B). Referring to FIG. 3A, in block 302, the processor 102 determines the display panel resolutions of the active connected display devices. An active display includes a display that is connected to the system 100 when powered on. Video driver software run by the processor 102, receive the EDID or other configuration data from the display devices. The configuration data associated with the two displays are processed to determine the respective display panel resolutions. The processor 100 determines which display has a higher resolution in block 304. In block 306, the LCDC registers are configured with the parameters associated with the higher resolution display. In block 308, the PLD registers are configured with the parameters of the display with the lower resolution. A DMA transfer is initiated in block 310. The DMA transfer includes transferring data from the buffer 106 to the LCDC 104. In block 312, the DMA data for the next frame to be displayed is sent to the PLD 108. Referring to FIG. 3B, in block 314, the video data having higher resolution is received by FIFO 1 120 from the LCDC 104. The data is clocked into the FIFO 1 120 via control pulses generated by the sync generator module 116 in block 316. The video data is sent from the FIFO 1 120 to the scaler 118 in block 318, and scaled by the scaler 118 to the lower resolution. In block 320, the scaled video data is clocked into the FIFO 2 via control pulses generated by the sync generator 116 in block 322. In block 324, the display data from the FIFO 1 120 and the FIFO 2 122 is switched into the appropriate interface converter (either A112 or B 110) via timing signals generated by the sync generator 116. The video data is sent from the interface converters A 112 and B 110 to the display devices A 103 and B 101 in block 326, and the display devices A 103 and B 101 display the data to a user.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer system comprising:
a processor including a display controller operative to output display data and a clock signal; and
a programmable logic device communicatively connected to the processor, the programmable logic device including:
a first FIFO (first in first out) module operative to receive display data from the display controller and output display data to a display device;
a second FIFO module;
a scaler module communicatively connected to the first FIFO module and the second FIFO module operative to scale the display data received from the first FIFO module and output the scaled display data to the second FIFO module; and
a synchronization generator operative to receive the clock signal from the display controller and to control the first FIFO and the second FIFO.

2. The system of claim 1, wherein the system further includes a first interface converter communicatively connected to the programmable logic device and the display device, the first interface converter operative to receive display data from the programmable logic device.

3. The system of claim 2, wherein the first interface converter is operative to receive timing signals from the synchronization generator and output the display data to the display device.

4. The system of claim 1, wherein the system further includes a second interface converter communicatively connected to the programmable logic device and a second display device, the second interface converter operative to receive display data from the programmable logic device.

5. The system of claim 4, wherein the second interface converter is operative to receive timing signals from the synchronization generator and output the display data to the second display device.

6. The system of claim 1, wherein the programmable logic device includes a register array operative to store configuration data to control the synchronization generator and the scaler.

7. The system of claim 6, wherein the register array is communicatively connected to the processor.

8. The system of claim 1, wherein the system further includes a switch communicatively connected to the first FIFO and the second FIFO.

9. The system of claim 1, wherein the system further comprises of a first buffer communicatively connected to the switch and to the first interface converter.

10. The system of claim 1, wherein the system further comprises of a second buffer communicatively connected to the switch and to the second interface converter.

11. The system of claim 1, wherein the synchronization generator includes a clock generator operative to receive the clock signal, and output a pulse signal to a first timing generator and a second timing generator.

12. A method for displaying data in a system, the method including:
receiving configuration data from a first display device and a second display device;
comparing the configuration data to identify which display device operates at a higher resolution;
configuring a first set of registers in the system with operating parameters associated with the higher resolution display;
configuring a second set of registers in the system with operating parameters associated with the lower resolution display;
receiving display data at the higher resolution and a pixel clock signal from a processor;
clocking the display data at the higher resolution into a first FIFO module;
scaling the display data from the higher resolution to the lower resolution;
clocking the display data at the lower resolution into a second FIFO module;
switching the display data at the higher resolution to the display device having higher resolution; and
switching the display data at the lower resolution to the display device having lower resolution.

13. The method of claim 12, wherein the first set of registers are associated with a display controller associated with the processor, and the second set of registers are associated with a programmable logic device.

14. The method of claim 12, wherein the display data at the higher resolution is switched from the first FIFO module to the interface converter associated with the higher resolution display device.

15. The method of claim 12, wherein the display data at the lower resolution is switched from the second FIFO module to the interface converter associated with the lower resolution display device

16. The method of claim 12, wherein clocking of the display data from the FIFO modules to the interface converters is synchronized with the respective timing signals generated by the synchronization generator.

17. A system comprising:
a processor operative to receive display data from a memory and output the display data and a pixel clock signal; and
a programmable logic device connected to the processor operative to receive the display data and the pixel clock signal and clock the display data into a first FIFO module, scale the display data from a first resolution into a second resolution, clock the scaled display data in the second resolution into a second FIFO module, switch the display data from the first FIFO module to an interface converter associated with a higher resolution display device, switch the display data from the second FIFO module to an interface converter associated with a lower resolution display device, and output the display data from the interface converters to the associated display devices.

18. The system of claim 17, wherein the processor is operative to receive a signal from the higher resolution display device indicating the resolution of the higher resolution display device.

19. The system of claim 17, wherein the processor is operative to receive a signal from the lower resolution display device indicating the resolution of the lower resolution display device.
